(19) United States
(12) Patent Application Publication
(10) Pub. No.: US 2025/0140880 A1
(43) Pub. Date: May 1, 2025

(54) COOLANT RESERVOIR INCLUDING ION FILTER

(71) Applicants: HYUNDAI MOTOR COMPANY, SEOUL (KR); KIA CORPORATION, SEOUL (KR)

(72) Inventors: Wook Il Jang, Yongin-si (KR); Hae Lee Lee, Seoul (KR); Young June Oh, Yongin-si (KR); Soo Hwan Kim, Yongin-si (KR)

(21) Appl. No.: 18/610,825

(22) Filed: Mar. 20, 2024

(30) Foreign Application Priority Data
Oct. 27, 2023 (KR) 10-2023-0145174

(51) Int. Cl. H01M 8/04044; H01M 8/04029

(52) U.S. Cl. CPC H01M 8/04044; H01M 8/04029

(57) ABSTRACT

A coolant reservoir includes an ion filter, the coolant reservoir includes a main body in which a coolant to cool a fuel cell stack is stored, and the ion filter configured to be selectively connected to a coolant line, through which the coolant flows, to remove ions contained in the coolant when a measured insulation resistance value of a fuel cell system changes.

### CROSS REFERENCE TO RELATED APPLICATIONS

This application claims, under 35 U.S.C. § 119 (a), the benefit of and priority to Korean Patent Application No. 10-2023-0145174, filed on Oct. 27, 2023, the entire contents of which are incorporated herein by reference.

### TECHNICAL FIELD

The present disclosure relates to a coolant reservoir including an ion filter. More particularly, it relates to a coolant reservoir including an ion filter capable of selectively exposing the ion filter to a coolant only when removal of ions present in the coolant is necessary.

### BACKGROUND

Generally, a fuel cell is a device configured to generate an electricity while generating water by receiving oxygen in the air and hydrogen as a fuel. In the fuel cell, high-purity hydrogen is supplied from a hydrogen storage tank to the anode of the fuel cell during operation, and atmospheric air is supplied directly to the cathode of the fuel cell using an air supplier, such as an air blower.

When the oxygen supplied to the fuel cell stack is separated into hydrogen ions and electrons in the catalyst of the anode and the separated hydrogen ions pass to the cathode through an electrolyte membrane, the oxygen supplied to the cathode combines with electrons introduced into the cathode through an external conductor to generate water and generate an electric energy.

The fuel cell system may include a fuel cell stack configured to generate an electric energy, a fuel supply system configured to supply a fuel (hydrogen) to the fuel cell stack, an air supply system configured to supply oxygen in the air, wherein the oxygen is an oxidizing agent necessary for electrochemical reactions, to the fuel cell stack, and a heat and water management system configured to control the operating temperature of the fuel cell stack.

Here, an ion filter, one of the components of the heat and water management system, serves to remove ionic substances from a coolant circulated through the fuel cell stack to extend the life of the fuel cell and stabilize the fuel cell system.

Therefore, an ion exchange resin, configured to substantially filter the ions contained in the coolant, is built in the ion filter, allowing the coolant circulating through the fuel cell stack to enter the ion filter and the ionic substances in the coolant to be removed and then to be circulated back to the fuel cell stack.

When the ion filter is installed in a vehicle, the electrical conductivity in the coolant should be managed at or below a predetermined level. However, when the ion filter is always exposed to the circulating coolant, the durable life of the ion filter may be shortened.

The above information disclosed in this Background section is only for enhancement of understanding of the background of the present disclosure, and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a coolant reservoir including an ion filter, wherein the reservoir has stored therein a coolant to cool a fuel cell stack and mounted therein the ion filter configured to remove ions present in the coolant to thereby facilitate the maintenance of the ion filter, and wherein the ion filter is selectively exposed to the coolant only when removal of ions present in the coolant within the reservoir is necessary, improving the durability of the ion filter.

In one aspect, the present disclosure provides a coolant reservoir including a main body in which a coolant to cool a fuel cell stack is stored, and an ion filter mounted within the main body and configured to be selectively connected to a coolant line, through which the coolant flows, to remove ions contained in the coolant when a measured insulation resistance value of a fuel cell system changes.

In a preferred embodiment, when the measured insulation resistance value is detected to be less than a set mounting resistance value, the mounting position of the ion filter may be lowered and the ion filter may be connected to the coolant line.

In another preferred embodiment, when the measured insulation resistance value is detected to be greater than a set detachment resistance value while the ion filter is connected to the coolant line, the mounting position of the ion filter may be raised and the ion filter may be disconnected from the coolant line.

In still another preferred embodiment, the detachment resistance value may be set greater than the mounting resistance value.

In yet another preferred embodiment, the ion filter may include a filter cartridge having built therein an ion exchange resin configured to filter the ions contained in the coolant, and an actuation member configured to provide a driving force for changing the mounting position of the filter cartridge.

In still yet another preferred embodiment, the filter cartridge may have a mesh net structure including the ion exchange resin.

In a further preferred embodiment, the main body may have an internal housing, having formed therein a coolant line through which the coolant flows and provided with an upright partition wall having a height greater than the water level of the coolant.

In another further preferred embodiment, the main body may have an internal housing, having formed therein a coolant line through which the coolant flows and provided with an upright partition wall having a height greater than the water level of the coolant.

In still another further preferred embodiment, in a state where the filter cartridge and a wire member are connected to each other, the actuation member may provide a driving force to raise or lower the filter cartridge with respect to the internal housing by adjusting the length of the wire member.

In yet another further preferred embodiment, in a state where the partition wall and the filter cartridge are engaged with each other, the actuation member may rotate the partition wall to provide a driving force to raise or lower the filter cartridge with respect to the internal housing.

In still yet another further preferred embodiment, in a state where the rotation axis of the filter cartridge is eccentrically coupled to the partition wall, the actuation member may rotate the rotation axis to provide a driving force to raise or lower the filter cartridge with respect to the internal housing.

In a still further preferred embodiment, the coolant reservoir including the ion filter may further include a water level sensor configured to detect the water level of the coolant by floating within the main body.

In a yet still further preferred embodiment, the ion filter may further change the mounting position thereof depending on the water level detected by the water level sensor.

Other aspects and preferred embodiments of the present disclosure are discussed infra.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing the structure of a coolant reservoir including an ion filter according to an embodiment of the present disclosure;

FIG. 2 and FIG. 3 are views illustrating the operation of a first embodiment of an ion filter for a coolant reservoir including the ion filter according to an embodiment of the present disclosure;

FIG. 4 is a view illustrating the operation of a second embodiment of an ion filter for a coolant reservoir including the ion filter according to an embodiment of the present disclosure;

FIG. 5 and FIGS. 6A, 6B, 6C, and 6D are views illustrating the operation of a third embodiment of an ion filter for a coolant reservoir including the ion filter according to an embodiment of the present disclosure;

FIG. 7 is a view illustrating a water level sensor for a coolant reservoir including an ion filter according to an embodiment of the present disclosure; and

FIG. 8 is a view showing a general thermal management system according to an embodiment of the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Description will now be given in detail according to preferred embodiments disclosed herein, with reference to the accompanying drawings.

Advantages and features of the present disclosure, and a method of achieving the same, will be apparent with reference to the embodiments described below in detail in conjunction with the accompanying drawings.

However, the present disclosure may be embodied in many different forms, and should not be construed as being limited to the embodiments set forth herein. Rather, the embodiments are provided so that the present disclosure will be thorough and complete, and will fully convey the scope of the present disclosure to those skilled in the art. The present disclosure is defined only by the categories of the claims.

In describing the present disclosure, if a detailed explanation of a related known function or construction is considered to unnecessarily obscure the gist of the present disclosure, such explanation has been omitted but would be understood by those skilled in the art.

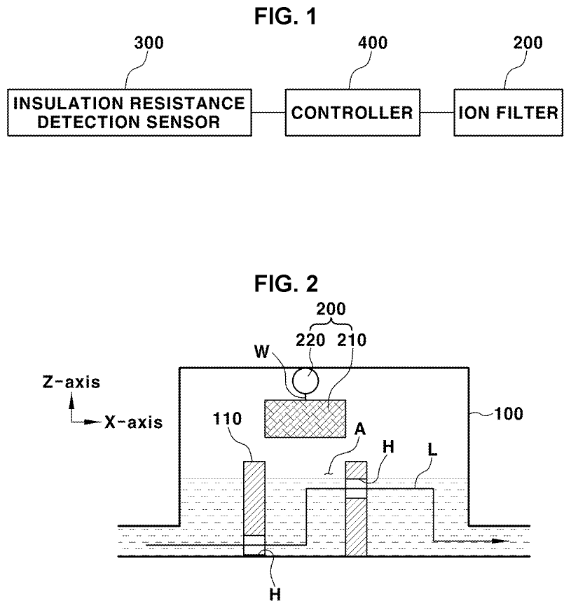

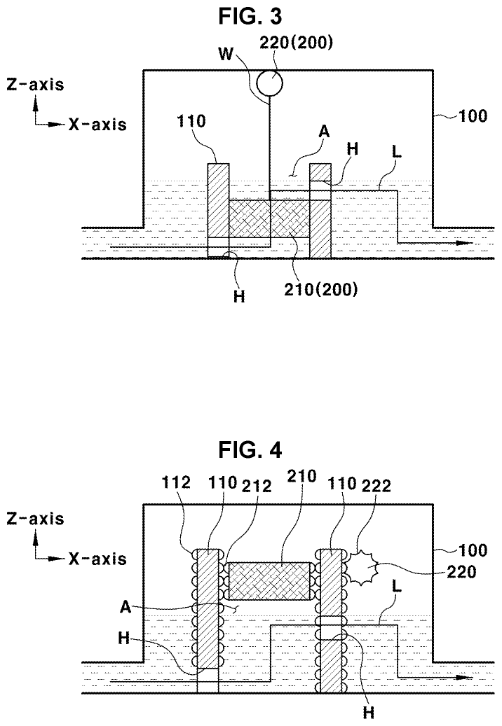

FIG. 1 is a view showing the structure of a coolant reservoir including an ion filter according to an embodiment of the present disclosure, and FIGS. 2 and 3 are views illustrating the operation of a first embodiment of an ion filter for a coolant reservoir including the ion filter according to an embodiment of the present disclosure.

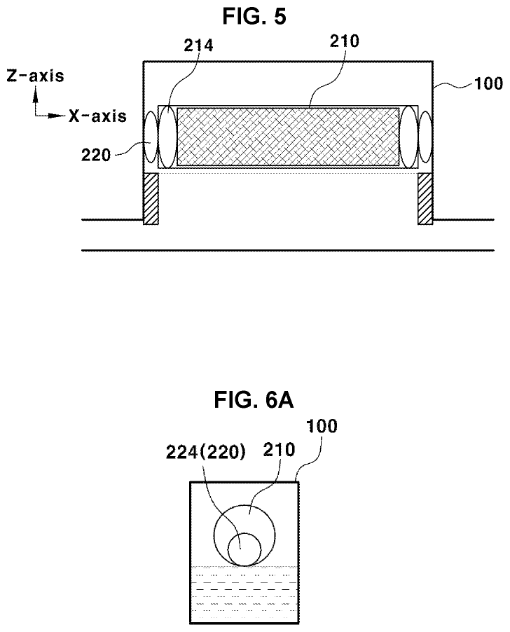

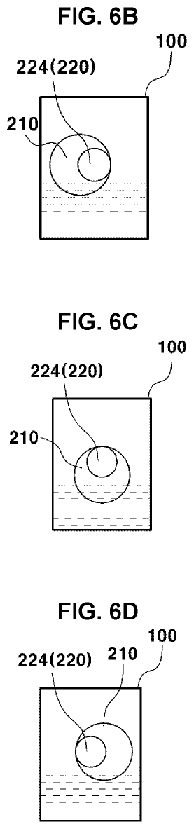

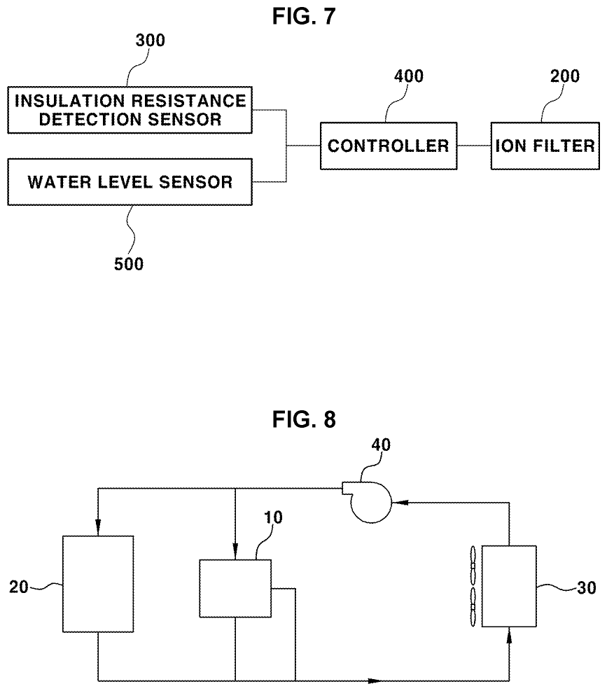

FIG. 4 is a view illustrating the operation of a second embodiment of an ion filter for a coolant reservoir including the ion filter according to an embodiment of the present disclosure, FIG. 5 and FIGS. 6A, 6B, 6C, and 6D are views illustrating the operation of a third embodiment of an ion filter for a coolant reservoir including the ion filter according to an embodiment of the present disclosure, and FIG. 7 is a view illustrating a water level sensor for a coolant reservoir including an ion filter according to an embodiment of the present disclosure.

FIG. 8 is a view to explain coolant exchange among a reservoir, a radiator, and a fuel cell stack in a thermal management system, and is a simplified view omitting portions unrelated to coolant exchange.

As shown in FIG. 8, a general thermal management system may require a reservoir 10, a fuel cell stack 20, a radiator 30, and a coolant pump 40 for coolant exchange.

The reservoir 10 may be a space where a coolant for cooling the fuel cell stack 20 is stored.

The fuel cell stack 20 is supplied with air and hydrogen to generate a power through a chemical reaction thereof, a coolant may be introduced into the fuel cell stack 20 to release heat, wherein the heat is a by-product generated by the chemical reaction of the fuel cell stack 20, and the coolant to cool the fuel cell stack 20 may be introduced into the radiator 30.

The radiator 30 may re-cool the coolant whose temperature has risen after the chemical reaction of the fuel cell stack 20 and may release the heat of the coolant to the outside. The coolant cooled in the radiator 30 may flow to a valve (not shown) configured to control the flow of the coolant.

The coolant pump 40 may supply the coolant delivered from the valve (not shown) to the fuel cell stack 20 and may control the flow rate of the coolant. The coolant discharged from the coolant pump 40 may be introduced into the reservoir 10 and the fuel cell stack 20.

Although not shown in the drawing, according to an embodiment of the present disclosure, an ion filter configured to filter ions contained in the coolant is installed separately in a thermal management system, causing difficulties in maintaining the ion filter, which must be replaced at regular intervals, and causing deterioration of the coolant due to catalysts being always exposed to the coolant.

Meanwhile, a coolant reservoir including an ion filter according to this embodiment to solve the above problems may include a main body 100 and a filter 200, as illustrated in FIG. 2.

The main body 100 stores a coolant for cooling a fuel cell stack.

The main body 100 is provided with a partition wall 110 to ensure the airtightness of an internal housing A, and the partition wall 110 is erected in the main body 110 by being integrated therewith so as not to be moved by the coolant.

More preferably, in allowing the coolant to flow in and out through inlet and outlet of the main body 100, the partition wall 110 forms a coolant line L through which the coolant flows, i.e., the partition wall 110 forms a coolant line L using a plurality of flow holes H having different heights, has a height greater than the water level of the coolant, and ensures airtightness of the internal housing A to prevent the coolant from flowing outside the coolant line L.

The ion filter 200 is mounted within the main body 100.

Because, unlike the prior art, the ion filter 200 is not separated from the main body 100, a separate line for ion filtration is not needed, reducing the number of lines and thus reducing the cost and volume of the thermal management system.

In addition, because the main body 100 is usually placed at a position to be easily accessible for maintenance, mounting the ion filter 200 within the main body 100 may facilitate the maintenance of the ion filter 200.

Moreover, when the insulation resistance value of the fuel cell system detected by an insulation resistance detection sensor 300 changes or when the coolant conductivity detected by a conductivity sensor (not shown) changes, the ion filter 200 is selectively connected to the coolant line L to remove ions contained in the coolant.

In other words, when the insulation resistance detection sensor 300 detects the measured insulation resistance value of the fuel cell system being less than a set mounting resistance value for a set number of times, e.g., less than 300 kΩ for 5 times, the mounting position of the ion filter 200 is lowered by a controller 400 and the ion filter 200 is connected to the coolant line L, as illustrated in FIG. 3.

As the ion filter 200 is connected to the coolant line L and the coolant flows therethrough, the ion filter 200 may filter the ions contained in the coolant circulating through the fuel cell stack using a built-in ion exchange resin.

When the insulation resistance detection sensor 300 detects the measured insulation resistance value of the fuel cell system being equal to or more than a set detachment resistance value for a set number of times, e.g., 400 kΩ or more for 5 times, while the ion filter 200 is connected to the coolant line L, the mounting position of the ion filter 200 is raised by the controller 400 and the ion filter 200 is disconnected from the coolant line L.

In other words, when any one selected from an insulation resistance value measured at a predetermined time point, an insulation resistance value measured more than once, an insulation resistance moving average value, and an insulation resistance moving central value satisfies the set condition, the mounting position of the ion filter 200 is raised by the controller 400 and the ion filter 200 is disconnected from the coolant line L.

Here, the detachment resistance value may be set greater than the mounting resistance value of 300 kΩ, for example, preferably set to 400 kΩ or more.

In this way, when the ion filter 200 is disconnected from the coolant line L, the disconnected state may be kept as long as possible. However, when the detachment resistance value is set to a level similar to the mounting resistance value, the ion filter 200 is frequently switched from being disconnected from the coolant line L to being connected to the coolant line L by the controller 400 depending on the measured insulation resistance value of the fuel cell system detected by the insulation resistance detection sensor 300, rendering it difficult to secure the durability of the ion filter 200.

For this reason, the detachment resistance value is set greater than the mounting resistance value to keep the disconnection between the ion filter 200 and the coolant line L as long as possible, thereby not only securing the durability of the ion filter 200 but improving the lifespan of an actuation member 220 configured to raise and lower the ion filter 200.

Meanwhile, for ion filtration and for being raised and lowered as mentioned above, the ion filter 200 includes a filter cartridge 210 and the actuation member 220.

The filter cartridge 210 has built therein the ion exchange resin for filtering ions contained in the coolant.

Preferably, the filter cartridge 210 may have a mesh net structure for the whole surface thereof including the ion exchange resin. However, the filter cartridge 210 may have a mesh net structure for two sides thereof, upper and lower, for cost effectiveness or, although not shown in the drawing, may have a mesh net structure at the central portion thereof and a border structure surrounding the mesh net structure to fix the same.

Owing to the mesh net structure, when the filter cartridge 210 is disconnected from the coolant line L depending on a predetermined condition in the state in which the mounting position of the filter cartridge 210 is lowered and the filter cartridge 210 is connected to the coolant line L, the coolant may be easily discharged without remaining within the filter cartridge 210 and reaction between the coolant and the ion exchange resin in the state of the filter cartridge 210 being disconnected from the coolant line L may be prevented, thereby further increasing the durable life of the filter cartridge 210.

The actuation member 220 is configured to provide a driving force to change the mounting position of the filter cartridge 210. The actuation member 220 may be a motor.

The actuation member 220 drives the filter cartridge 210 at a low speed to improve emotional quality. In other words, because filtration of ions from the coolant is chemically slow and thus the filter cartridge 210 does not need to be rapidly raised or lowered, the actuation member 220 drives the filter cartridge 210 at a lower speed. For example, the time for raising or lowering the mounting position of the filter cartridge 210 is secured to a maximum of 30 seconds to minimize noise generated due to the raising or lowering of the filter cartridge 210.

The actuation member 220 may be provided in plural to raise and lower the filter cartridge 210.

### First Embodiment

As illustrated in FIGS. 2 and 3, in the state in which the filter cartridge 210 and a wire member W are connected to each other, the actuation member 220 provides a downward driving force to elongate or shorten the length of the wire member W so that the filter cartridge 210 is connected to the internal housing A, more specifically, to the coolant line L.

In other words, when the actuation member 220 is driven to rotate the wire member W in a winding direction, the wire member W is wound and the filter cartridge 210 is raised to be disconnected from the coolant line L (see FIG. 2).

On the other hand, when the actuation member 220 is driven to rotate the wire member W in a direction opposite the winding direction while the filter cartridge 210 is disconnected from the coolant line L, the wound wire member W is released and the filter cartridge 210 is lowered to be connected to the coolant line L (see FIG. 3).

### Second Embodiment

As illustrated in FIG. 4, the actuation member 220 has a plurality of gear teeth 222, is engaged with the partition wall 110.

The partition wall 110 provided with a rack gear 112 and the filter cartridge 210 provided with a pinion gear 212 are engaged with each other. With this structure, when the actuation member 220 rotates, the partition wall 110 engaged with the actuation member 220 rotates, and accordingly the filter cartridge 210 engaged with the partition wall 110 is lowered in a direction to be connected to the coolant line L.

More preferably, depending on forward or reverse rotation of the partition wall 110 rotated by the actuation member 220, the filter cartridge 210 is raised in a direction to be disconnected from the coolant line L or lowered in a direction to be connected to the coolant line L, implementing a sturdier raising and lowering structure compared to the first embodiment described above.

### Third Embodiment

Like in the first embodiment and the second embodiment, the filter cartridge 210 may be selectively connected to the coolant line L by moving in a vertical direction. However, in addition to this, the filter cartridge 210 may be selectively connected to the coolant line L by rotating.

In other words, as illustrated in FIGS. 5 and 6, the actuation member 220 is located at a predetermined height within the main body 100 by the partition wall 110, and has a rotation axis 224 eccentrically coupled to a coupling member 214 at a corresponding one of the opposite sides of the filter cartridge 210. The actuation member 220 rotates about the rotation axis 224 eccentrically coupled to the coupling member 214 to provide a driving force to raise the filter cartridge 210 from the internal housing A.

More specifically, as illustrated in FIG. 6A, when the rotation axis 224 rotates in a state in which the filter cartridge 210 is disconnected from the coolant line L, the filter cartridge 210 sequentially rotates along a predetermined rotation radius by the eccentrically coupled rotation axis 224 and moves in a direction to be connected to the coolant line L, as illustrated in FIGS. 6B and 6C.

Moreover, when the actuation member 220 sequentially rotates the rotation axis 224 in the same direction as above depending on the change in the measured insulation resistance value of the fuel cell system, the filter cartridge 210 rotates to move in a direction to be disconnected from the coolant line L, as illustrated in FIG. 6D.

As a result, in the coolant reservoir including the ion filter according to this embodiment, the mounting position of the filter cartridge 210 changes in the vertical or rotational direction and the filter cartridge 210 is exposed to the coolant only when removal of ions present in the coolant is necessary based on changes in the measured insulation resistance value of the fuel cell system, and thus the chemical reaction for ion filtration does not have to continuously occur, improving the durability and durable life of the ion filter 200.

Meanwhile, the coolant reservoir including the ion filter according to this embodiment may further include, as illustrated in FIG. 7, a water level sensor 500 configured to detect the water level of the coolant by floating within the main body 100.

The mounting position of the ion filter 200 may further be changed depending on the water level detected by the water level sensor 500.

In other words, the water level sensor 500 may not only detect a shortage of coolant based on the information on the water level of the coolant, but when the water level of coolant is detected to be greater than a maximum water level and the filter cartridge 210 does not need to be connected to the coolant line L, may also further raise the filter cartridge 210 from its initial position by sending the water level information to the controller 400.

Here, when the water level of coolant detected by the water level sensor 500 reaches the maximum water level and the filter cartridge 210 is determined to be positioned at a set maximum height, the controller 400 may deliver a notification to a user to remove the coolant, preventing problems of reducing the durability and durable life of the ion filter 200 due to the filter cartridge 210 being connected to the coolant line L when not needed.

As is apparent from the above description, the present disclosure provides the following effects.

According to the present disclosure, provided is a reservoir having stored therein a coolant to cool a fuel cell stack and mounted therein an ion filter configured to remove ions present in the coolant to thereby facilitate the maintenance of the ion filter.

Moreover, according to the present disclosure, the ion filter is selectively exposed to the coolant only when removal of ions present in the coolant within the reservoir is necessary, improving the durability of the ion filter.

In the above, embodiments of the present disclosure have been described with reference to the accompanying drawings. However, those skilled in the art to which the present disclosure pertains will understand that various modifications may be made therefrom, and that all or part of the above-described embodiment(s) may be selectively combined. Therefore, the true technical protection scope of the present disclosure should be determined by the technical ideas of the appended claims.

1. A coolant reservoir comprising:
an ion filter; and
a main body in which a coolant to cool a fuel cell stack is stored;
wherein the ion filter is mounted within the main body and configured to be connected to a coolant line, through which the coolant flows, to remove ions contained in the coolant when a measured insulation resistance value of a fuel cell system changes.

2. The coolant reservoir of claim 1, wherein, when the measured insulation resistance value is less than a set mounting resistance value, a mounting position of the ion filter is lowered and the ion filter is connected to the coolant line.

3. The coolant reservoir of claim 2, wherein, when the measured insulation resistance value is greater than a set detachment resistance value while the ion filter is connected to the coolant line, the mounting position of the ion filter is raised and the ion filter is disconnected from the coolant line.

4. The coolant reservoir of claim 3, wherein the set detachment resistance value is set greater than the set mounting resistance value.

5. The coolant reservoir of claim 1, wherein the ion filter comprises:
a filter cartridge having an ion exchange resin configured to filter the ions contained in the coolant; and
an actuation member configured to provide a driving force for changing a mounting position of the filter cartridge.

6. The coolant reservoir of claim 5, wherein the filter cartridge has a mesh net structure comprising the ion exchange resin.

7. The coolant reservoir of claim 5, wherein the main body has an internal housing including a coolant line through which the coolant flows, and the internal housing further including an upright partition wall having a height greater than a water level of the coolant.

8. The coolant reservoir of claim 7, wherein, when the filter cartridge and a wire member are connected to each other, the actuation member provides a driving force configured to raise or lower the filter cartridge with respect to the internal housing by adjusting a length of the wire member.

9. The coolant reservoir of claim 7, wherein, when the upright partition wall and the filter cartridge are engaged with each other, the actuation member rotates the upright partition wall to provide a driving force to raise or lower the filter cartridge with respect to the internal housing.

10. The coolant reservoir of claim 7, wherein, when a rotation axis of the filter cartridge is eccentrically coupled to the upright partition wall, the actuation member rotates the rotation axis to provide a driving force to raise or lower the filter cartridge with respect to the internal housing.

11. The coolant reservoir of claim 1, further comprising a water level sensor configured to detect a water level of the coolant by floating within the main body.

12. The coolant reservoir of claim 11, wherein the ion filter is configured to change a mounting position depending on the water level detected by the water level sensor.
